(19) United States
(12) Patent Application Publication
(10) Pub. No.: US 2010/0210356 A1
(43) Pub. Date: Aug. 19, 2010

(54) SYSTEM FOR COMPUTERIZED MULTIPLAYER TOURNAMENT GAMING AND A METHOD THEREOF

(75) Inventor: Idan Losica, Douglas (GB)

Correspondence Address: OLIFF & BERRIDGE, PLC, P.O. BOX 320850, ALEXANDRIA, VA, 22320-4850, US

(73) Assignee: PLAYTECH SOFTWARE LIMITED, Douglas, Isle of Man (GB)

(21) Appl. No.: 12/676,441

(22) PCT Filed: Sep. 4, 2008
(86) PCT No.: PCT/IL2008/001195

§ 371 Date: Mar. 4, 2010

(30) Foreign Application Priority Data
Sep. 5, 2007 (IB) PCT/IB2007/053577

(51) Int. Cl. G06F 17/00

(52) U.S. Cl. 463/26; 463/25; 463/42

(57) ABSTRACT

The present invention discloses a computerized gaming system for multiplayer tournaments, a method of operating the system, a module to be used in conjunction with the system, and a method of playing the game. The method of operating the system comprises a) setting and accommodating a configuration comprising one or more predefined and/or configurable rules for multiplication of stakes and/or a winning pool, conditions thereof, one or more parameters of said multiplication, and one or more tournament limits; b) facilitating obtaining a multiplication proposal from a player; c) obtaining game-related and/or player-related data from the gaming server and/or the billing unit and/or the storage unit, and providing automated authorization of the proposal in accordance with said obtained data and said accommodated configuration; d) presenting the authorized proposal to one or more other players and facilitating obtaining one or more respective replies, e) automated informing the game server and/or the billing unit with regard to the multiplication proposal and reply thereof; and f) automated executing the game rules corresponding to the obtained replies.

### FIELD OF THE INVENTION

The present invention generally relates to computerized gaming over a communication network, and more particularly to computerized multiplayer tournament gaming involving games of chance.

### BACKGROUND OF THE INVENTION

Computerized multiplayer tournaments are well known in prior art. Generally, the players participate in a number of rounds, each round involving one or more instances of a virtual game in which players participate. Depending on the type of game, each instance may involve one or more hands, turns, spins, or other wagering events during the virtual game. For example, in a computerized poker tournament, the game instance may be a virtual poker table, at which players may play poker against each other.

In a typical poker game, each player receives a set of cards. Players can either replace some of the cards or hold the cards they receive. The winner of the game is the player holding a set of cards having a predetermined combination of cards determined to be superior to the combinations of other players. One cycle of the game (typically dealing the cards and a showdown at the end) is referred to as a “hand”. There are many variations of poker games as, by way of non-limiting example, variations in the number of cards used for the game, the number of cards dealt to each player, the rate at which cards are dealt, the rate and number of cards allowed to be changed during a hand, the time in the game when cards are revealed, as well as whether cards are revealed at all, and other variations. The are also many variations of poker tournaments which may differ by criteria for a new round start and entry, criteria for ending the tournament, tournament prize calculation and distribution and/or otherwise. The terms “poker tournament” or “tournament” used in this patent specification shall be expansively construed to include any poker card game including more than one hand.

At the beginning of the tournament a player who registers to play is required to pay a buy-in amount and a fee which goes to the room, and is awarded, accordingly, a certain quantity of tournament chips. The paid buy-in is pooled together with the other players' buy-ins and becomes the prize pool. For example a $5+$0.5 tournament has a $5 buy-in (which means that a 10-player tournament will have a prize pool of $50) and a $0.50 tournament fee (the room will thus earn $5 from such a 10-player tournament).

Computerized multiplayer tournament games may be implemented in various ways known in the art as disclosed, for example, in the following patents and patent applications:

U.S. Pat. No. 6,755,741 discloses a gambling game system comprising a central station including a plurality of betting-type game devices, and an electronic camera for each game device. A plurality of player stations are remotely located with respect to the central stations, each one including a monitor for displaying a selected game device at the central station, and input means for selecting a game device and for placing a bet by a player at the player's station relating to an action involving an element of change to occur at the selected game device.

U.S. Pat. No. 7,362,862 discloses a method and a system for a distributed electronic tournament system in which many remotely located players participate in a tournament through input/output devices connected to a central controller which manages the tournament. The method includes the steps of (a) uniquely identifying a player communicating with the central controller via an associated input/output device; (b) responding to payment of an entry fee by the player for allowing the player to participate in a tournament occurring within a fixed time window via an associated input/output device; (c) accessing a database to store in the database, player information that is generated as the player participates in the tournament, such information being available for use in a subsequent tournament, which is administered by said controller and in which the player participates; and (d) awarding the player a prize for achieving a pre-established performance level in the tournament. In another preferred embodiment, the method further includes the steps of determining whether the player has been qualified to advance to a subsequent game session, in which at least one player is eliminated from the previous game session; and permitting each player qualified to a subsequent game session to participate in that game session.

U.S. Pat. No. 6,969,320 discloses a back office system comprising one or more central computers. Each central computer stores a number of game records with each game record representing a play in a game. A database computer included in the back office system maintains an account for each authorized player in the gaming system. A casino floor system is operatively connected for communication with the back office system and includes a number of player terminals through which players may participate in various games offered in the gaming system. Each player terminal in the casino floor system is serviced by one central computer in the back office system. Each player terminal allows a player to log in and make a request for a game play, and then communicates the entered game play request to the respective central computer servicing that particular player terminal. In response to the game play request from the player terminal, the central computer system reads a selected game record from the group of game records stored in the back office system and identifies the result associated with the game record. The central computer also directs the database computer to change the player's account balance according to the game play request and result of the selected game record. The central computer also sends information regarding the game play result back to the player terminal, which then uses the information to notify the player of the result.

US Patent Application No. 2005/209001 discloses a system for playing a zero-sum game such as multiplayer poker. The system includes a gaming server operable under program control to regulate the progress of one or more instances of the zero-sum game, and a number of portal websites on the World Wide Web of the Internet. The gaming server is also accessible on World Wide Web and enables participation in the instance of the zero-sum game by a predetermined number of players. The gaming server initiates further instances of the zero-sum game when all prior instances of the game have the predetermined plurality of participating players. Each player is able to access the gaming server by means of a corresponding Internet-enabled computer workstation, access for each player occurring through a respective one of the number of portal websites. The system maintains a register of players participating in the instance of the game. The register includes, for each participating player, data representative of a corresponding portal website through which the player accessed the gaming server. The gaming server provides a wagering facility operable by each player to place a wager on the instance of the zero-sum game, as well as a discrimination facility responsive to progress of the instance of the zero-sum game to determine whether any wager placed by any one of the participating players is successful or unsuccessful. The gaming server maintains a clearing account corresponding to each one of the number of portal websites and each portal maintains a credit account for each player who is participating in the instance of the zero-sum game through that portal. The gaming server credits the clearing account of a portal associated with a player who has made a successful wager on the instance of the game with an amount equivalent to the total of all the unsuccessful wagers in that turn.

US Patent Application 2008/045287 discloses a system and method for facilitating play of a game of chance by multiple players at multiple locations using a virtual card deck. The system includes a plurality of terminals at the multiple locations, the terminals receiving wagers from the plurality of players, the plurality of terminals issuing tickets to the plurality of players. Each ticket includes a respective player hand chosen from the virtual card deck and an identification code uniquely identifying the ticket. The system includes a plurality of displays at the multiple locations, the displays displaying a shared community hand chosen from the virtual card deck. The system includes a server in communication with the plurality of terminals and the plurality of displays. The server selects a set of removed cards from the virtual card deck prior to issuing tickets for the game. The server receives an indication of each player's wager from a terminal and responsively provides a respective unique identification number and a respective player hand for inclusion on the ticket delivered to the player, each player hand chosen from the virtual card deck but not from the set of removed cards. The server selects the shared community hand from the set of removed cards and communicates the shared community hand to the plurality of displays for display. The server determines if a ticket is a winning ticket in accordance with predetermined game rules, based on the player hand included on the ticket and the shared community hand.

### SUMMARY OF THE INVENTION

In accordance with certain aspects of the present invention, there is provided a method of operating a computerized multiplayer tournament gaming system comprising a gaming server operatively coupled to a billing unit and a storage unit, the method comprising:
setting and accommodating a configuration comprising one or more predefined and/or configurable rules for multiplication of stakes and/or a winning pool, conditions thereof, one or more parameters of said multiplication, and one or more tournament limits;
facilitating obtaining a multiplication proposal from a player;
obtaining game-related and/or player-related data from at least one element from a group comprising the gaming server, the billing unit and the storage unit; and providing automated authorization of the proposal in accordance with said obtained data and said accommodated configuration;
presenting the authorized proposal to one or more other players and facilitating obtaining one or more respective replies,
automated informing the game server and/or the billing unit with regard to the multiplication proposal and reply thereof; and
automated executing the game rules corresponding to the obtained replies.

In accordance with other aspects of the present invention there is provided a computerized multiplayer tournament gaming system comprising a gaming server operatively coupled to a billing unit and a storage unit, wherein the system further comprises:
a multiplier module operatively coupled to at least one element of a group comprising the gaming server, the billing unit and the storage unit;
at least one element of said group is configured to provide game-related data and/or player-related data to the multiplier module;
the multiplier module is configured:
   to accommodate a configuration comprising one or more predefined and/or configurable rules for multiplication of stakes and/or a winning pool, and/or conditions thereof; and/or one or more parameters of said multiplication, and/or one or more tournament limits;
   to obtain game-related data and/or player-related data from at least one element of said group;
   to facilitate obtaining a multiplication proposal from a player;
   to process the obtained data and the obtained multiplication proposal in accordance with the accommodated rules and conditions in order to provide an automated authorization of the proposal,
   to facilitate presenting the authorized proposal to one or more other players and obtaining one or more respective replies, and
   to inform the game server and/or the billing unit with regard to the multiplication proposal and reply thereof.

In accordance with other aspects of the present invention, there is provided a multiplier module configured for use with a computerized multiplayer tournament gaming system comprising a gaming server operatively coupled to a billing unit and a storage unit, wherein said multiplier module is operatively coupled to at least one element of a group comprising the gaming server, the billing unit and the storage unit and configured:
to accommodate a configuration comprising one or more predefined and/or configurable rules for multiplication of stakes and/or a winning pool, conditions thereof, one or more parameters of said multiplication, and one or more tournament limits;
to obtain game-related data and/or player-related data from at least one element of said group;
to facilitate obtaining a multiplication proposal from a player;
to process the obtained data and the obtained multiplication proposal in accordance with the accommodated rules and conditions in order to provide an automated authorization of the proposal,
to facilitate presenting the authorized proposal to one or more other players and obtaining one or more respective replies, and
to inform the game server and/or the billing unit with regard to the multiplication proposal and reply thereof.

In accordance with other aspects of the present invention, there is provided a method of playing a computerized multiplayer tournament game, the method comprising:
setting one or more rules for multiplication of stakes and/or a winning pool, conditions thereof, one or more parameters of said multiplication, and one or more tournament limits;
facilitating obtaining a multiplication proposal from a player;
automated authorization of the proposal in accordance with said rules and conditions;
presenting the authorized proposal to one or more other players and facilitating obtaining one or more respective replies,
automated executing the game rules corresponding to the obtained replies.

In accordance with further aspects of the present invention, the configuration may comprise a multiplication parameter may be predefined as a constant throughout the game or a plurality of predefined multiplication parameters corresponding to different points of a game flow. The multiplication parameter may be provided by a player together with the multiplication proposal and/or with reply thereof.

In accordance with further aspects of the present invention, the tournament limits may comprise a multiplication guarantee limit defined for each player and/or certain groups of players and/or globally to the game. At least one tournament limit may be re-configured in accordance with obtained multiplication proposal and/or reply thereof and/or data obtained from the gaming server and/or the billing unit and/or the storage unit.

In accordance with further aspects of the present invention, there may be provided automated triggering of a multiplication proposal option, thus facilitating a player to provide the multiplication proposal. The automated triggering may comprise automated recognition of a certain point in the game flow where the multiplication is allowed by the accommodated and automated verifying if this point meets the accommodated conditions for automated triggering. Said verification may be provided in accordance with accommodated configuration and data obtained from the gaming server and/or the billing unit and/or the storage unit.

In accordance with further aspects of the present invention, the automated authorization may comprise verifying at least one of the following:
if respective player is allowed to provide the multiplication proposal;
if the winning pool resulting from the obtained multiplication proposal fits the tournament limits,
if the multiplication guarantee obtained from the respective player fits the tournament pre-defined value,
   The verification may be provided in accordance with accommodated configuration and data obtained from the gaming server and/or the billing unit and/or the storage unit.

In accordance with further aspects of the present invention there is provided automated defining the players who shall reply to the multiplication proposal in accordance with accommodated configuration and data obtained the gaming server and/or the billing unit and/or the storage unit; and presenting the multiplication proposal accordingly.

In accordance with other aspects of the present invention, there is provided a method of playing a computerized multiplayer tournament game, the method comprising:
setting one or more rules for multiplication of stakes and/or a winning pool, conditions thereof, one or more parameters of said multiplication, and one or more tournament limits;
facilitating obtaining a multiplication proposal from a player;
automated authorization of the proposal in accordance with said rules and conditions;
presenting the authorized proposal to one or more other players and facilitating obtaining one or more respective replies,
automated executing the game rules corresponding to the obtained replies.

### BRIEF DESCRIPTION OF THE DRAWINGS

In order to understand the invention and to see how it may be carried out in practice, certain embodiments will now be described, by way of non-limiting example only, with reference to the accompanying drawings, in which:

FIG. 1 illustrates a generalized network environment wherein the present invention may be implemented;

FIG. 2 illustrates a schematic flowchart of a method of operating the gaming system in accordance with certain embodiments of the present invention;

FIG. 3 illustrates a generalized functional block diagram of a gaming system in accordance with certain embodiments of the present invention;

FIG. 4 illustrates an exemplary game flow in accordance with certain embodiments of the present invention.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. In the drawings and description, identical reference numerals indicate those components that are common to different embodiments or configurations.

Unless specifically stated otherwise, as apparent from the following discussions, it is appreciated that throughout the specification discussions utilizing terms such as “processing”, “computing”, “calculating”, “determining”, “generating”, “recognizing”, “setting”, “configuring” or the like, refer to the action and/or processes of any combination of software hardware and firmware that manipulate and/or transform data represented as physical, such as electronic, quantities within the computing system's registers and/or memories into other data, similarly represented as physical quantities within the computing system's memories, registers or other such information storage, transmission or display devices.

The processes/devices presented herein are not inherently related to any particular electronic component or other apparatus, unless specifically stated otherwise. Various general purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The references cited in the background teach many principles of implementing and managing computerized network games that are applicable to the present invention. Therefore the full contents of these publications are incorporated by reference herein where appropriate for appropriate teachings of additional or alternative details, features and/or technical background.

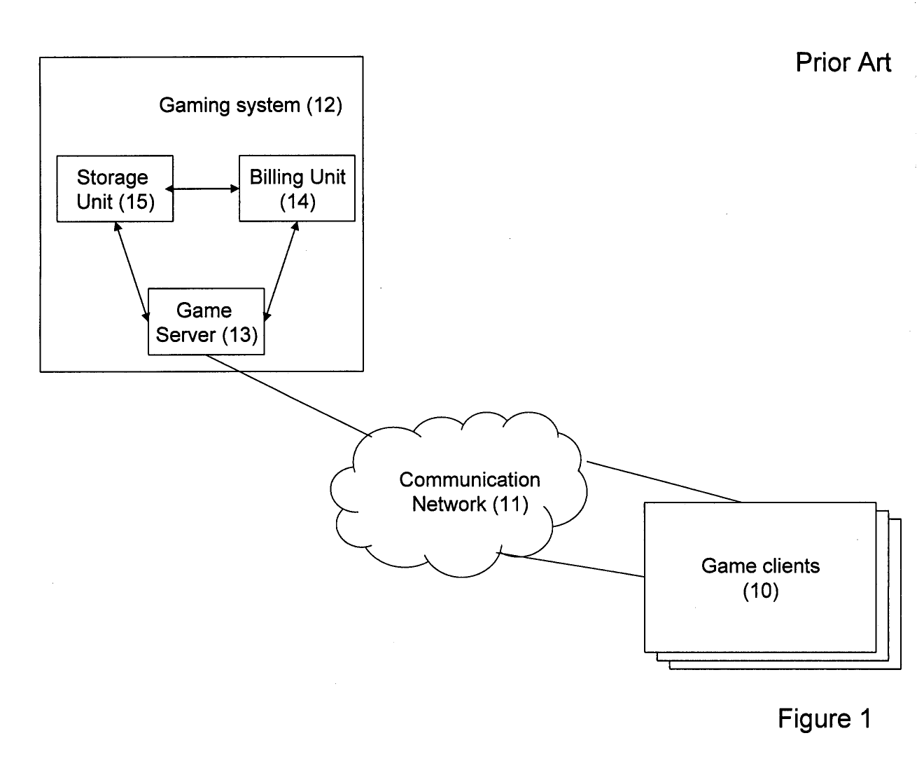

Bearing this in mind, attention is drawn to FIG. 1 illustrating a generalized network environment wherein the present invention may be implemented. The illustrated network environment comprises a plurality of game clients 10 operatively coupled to a game server 13 comprised in a gaming system 12. The game clients may be associated with any device having input and display capabilities (e.g. personal computer, workstation, PDA, mobile phone, WebTV device, wagering machine, adaptive gaming machine, etc.) and capable to communicate with the game server 13 directly or via communication network 11 (e.g. Wireline or Wireless Public Telephone Networks, Internet, Intranet, cable network, etc.). Optionally, such a device may further have a video capturing capabilities device and/or audio output capabilities.

The game clients may be downloaded to the respective device and/or accessed with the help of such a device from the web via a web browser. In certain embodiments of the invention the device shall be also capable to execute at least part of a gaming application. In certain embodiments of the invention the game clients may be directly associated with the gaming system 12 (e.g. a game system in a land-based casino may support one or more directly associated clients).

In certain embodiments of the invention there may be provided an exchange of live video/audio inputs between the clients (and/or associated devices) and the game server. A part of the respective display capabilities may be reserved for the showing of the video image of the other players and/or dealer.

The game server 13 is configured to receive input data from one or more game clients, to execute logic of one or more certain poker games accordingly, and to report outcome(s) to the game clients in accordance with gaming principles and rules. Server 13 may be configured as a server-side gaming application, wherein each gaming client 10 may be configured to execute the corresponding client-side. The sharing of functions between the game server and the game clients may vary depending on the game and implementation thereof, for example the game client may provide only functions of input/output and/or additionally execute certain programs related to output graphics and/or additionally execute part or all programs related to a game logic and exchange the data with the game server, etc. The server and client applications may comprise software components written in any appropriate programming language such as, by way of non-limiting example, C, C#, C++, Java, VB, VB.Net, or the like, and developed under any appropriate development environment, such as, by way of non-limiting example, Visual Studio.Net, J2EE or the like. It will be appreciated that server and/or the clients can alternatively be implemented as firmware ported for a certain processor such as, by way of non-limiting example, digital signal processor (DSP) or microcontrollers, or can be implemented as hardware or configurable hardware such as by way of non-limiting example, field programmable gate array (FPGA) or application specific integrated circuit (ASIC).

The game system further comprises a storage unit 15 operatively coupled to the game server 13. The storage unit is configured to accommodate all necessary information related to the games and users, including configuration of the game server (e.g. available games, game limits, etc.), users data and profiles, subscription management data and subscriber management (e.g. data related to opening an account for a user, closing an account, allowing a user to add or withdraw funds from an account, changing the user's address or personal identification number, etc.), session histories, detailed game results, monetary transactions, statistical data, etc. By way of non-limiting example, user-related data may include the user's name, address, age, gender, marital status, number of children, salary, occupation, hobbies and preferences or any other personal data. Additionally, user-related data may include data related to the gaming of certain users, for example, number and sums of wagers during the former week, favorite fields of games, sum of money won, bonuses, etc.

The gaming system may comprise other servers (not shown) operatively coupled to the storage unit 15, as, by way of non-limiting example, security server, administration server, live game server and others. The servers are configured to exchange data with the storage unit 15 and/or gaming server 13.

The game system further comprises a billing unit 14 operatively coupled to the game server 13 and the storage unit 15. In certain embodiments of the invention the billing unit may be also operatively coupled to the game clients. The billing unit is configured to accommodate and to manage user accounts and to enable performing of monetary transactions in accordance with data received from the game server, the storage unit and, optionally, the user.

Note that the invention is not bound by the specific architecture described with reference to FIG. 1. Those versed in the art will readily appreciate that the invention is, likewise, applicable to any network architecture facilitating computerized network-based gaming, and more particularly, computerized multiplayer poker tournament gaming.

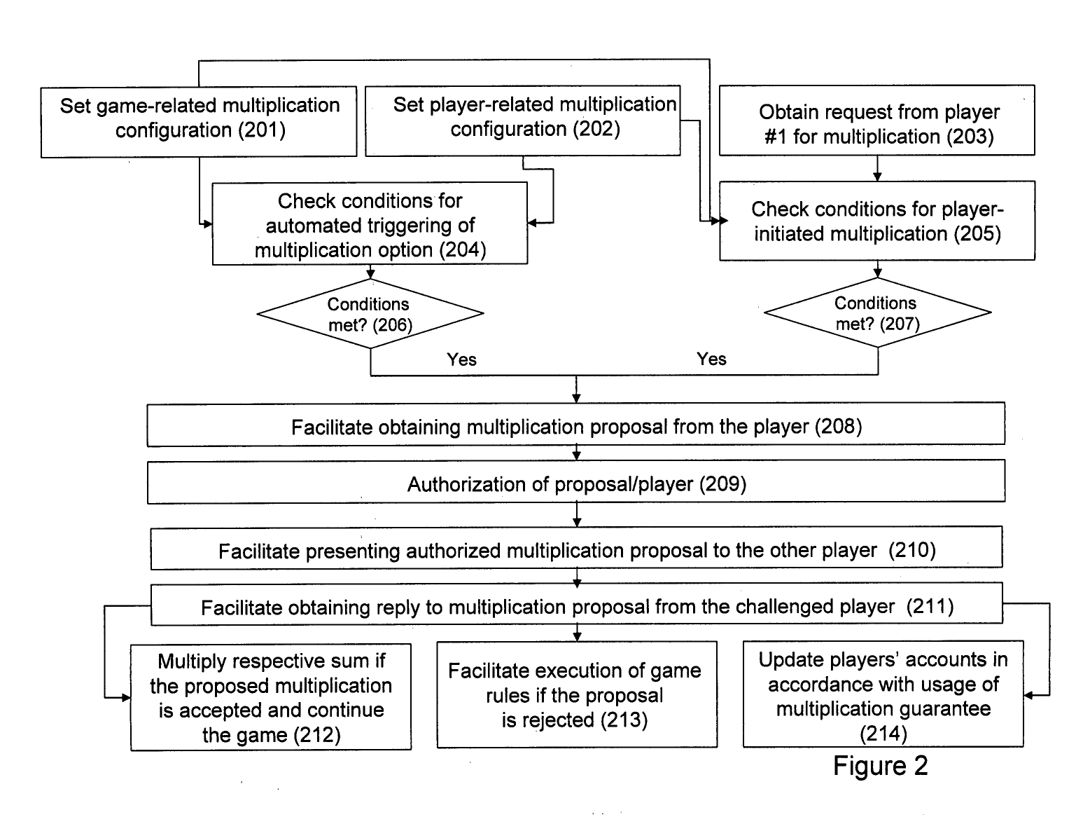

Referring now to FIG. 2, there is provided a generalized flowchart of operating the gaming system in accordance with certain embodiments of the present invention. As will be further detailed with references to FIGS. 2-4, the players are provided with an option to multiply, in accordance with pre-defined rules, current stakes and/or a winning pool at different stages of the poker tournament by a certain multiplication parameter, The multiplication is proposed by one player and is accepted/rejected by one or more other players. The multiplication parameter may be predefined by the system and/or selected by the players within a predefined range; the parameter (and/or the range of parameters) may be constant throughout the game or may depend on the game stage. By way of non-limiting example, the players may be provided with an option to double a winning pool of any hand (and/or any round) before it starts, or the rules may define the minimal and/or maximal number of hands before doubling; or the doubling may be provided at any time during the game; or the multiplying parameter may increase (or decrease) with each successive hand (and/or round), etc. Accordingly, operation 201 of setting game-related multiplication configuration includes setting multiplication rules, conditions and multiplication parameters, thus defining conditions and points of the game flow enabling multiplication and the respective multiplication parameters (including allowed multiplication range, if actual). Setting the game-related multiplication configuration includes also setting the tournament limits. In certain embodiments of the invention one or more limits may be constant or may vary during the game depending on different parameters (as, for example, current number of players, current and/or maximal multiplication parameter, etc.). For variable limits the configuration comprises the rules of the limits update with changing the respective parameters. At least part of the tournament limits refers to money or money equivalents (e.g. initial tournament fees, tournament winning pool, etc.); the limits may be related to other game characteristics as, for example, number of hands to be played in a round, multiplication limit(s) (e.g. total number of multiplication options per player and/or hand and/or round and/or tournament), as well as other limits depending on the poker variant played. Setting the tournament limits includes setting a player's multiplication guarantee limit. By way of non-limiting example, such a limit may be calculated as (buy-in+fee)*multiplication limit.

Operation 202 of setting player-related multiplication configuration is optional and includes setting conditions, multiplication parameters and limits in accordance with player-related data (e.g. geography, age, game and billing history, allowed limits and guarantees, etc.).

The game and player-related configurations include conditions for automated triggering of the multiplication proposal option and/or for facilitating a player-initiated multiplication. If certain embodiments of the invention support the player-initiated multiplication, the method of operating the game system further includes obtaining (203) multiplication request from a player #1.

In accordance with certain embodiments of the present invention, the gaming system provides automated check (204) if current game situation matches to conditions of automated triggering the multiplication proposal option. In certain embodiments of the invention the gaming system may recognize a certain point in the game flow where the multiplication is allowed by predefined rules (e.g. start of hand, end of hand, etc.) and to determine (206) if this point meets the pre-configured conditions for automated triggering (e.g. multiplication proposal may be allowed per minimal/maximal number of hands, only if the certain hand is not the last hand, etc.).

The gaming system defines who is the player (or, optionally, players) allowed to execute the multiplication proposal option and facilitates obtaining (208) a multiplication proposal from a respective player (player #1). For example, the player may receive an announcement (within the game interface, independently via Internet, phone or otherwise) that he/she may use the multiplication proposal option. This announcement may also comprise characteristics of the option, e.g. multiplication parameter (or range for selection), the other player (or a list of other players for information and/or selection) who should accept/reject the multiplying proposal, etc. Depending on embodiments of the present invention, the player #1 may perform the multiplication proposal by checking the option presented via a multiplication interface of a game screen, by reply on respective received SMS and/or e-mail and/or otherwise. Enabling obtaining (208) the multiplication proposal from player #1 may include displaying the special proposal interface to the player #1 or updating the game interface respectively.

Alternatively or additionally, the player #1 may initiate (203) a multiplication proposal. Upon receiving the respective request, the gaming systems checks (205) in a similar manner if current game situation and the player #1 match multiplication proposal conditions. If the conditions are met (207), the player #1 is enabled (208) to perform the multiplication proposal (within the game interface, independently via Internet, phone or otherwise).

When checking the match to conditions (204 or 205), the game system also defines who is the challenged player(s) to accept/reject the respective proposal at the current point in the game flow depending on the preconfigured rules (e.g. a winner or a loser of a current hand, certain number of hands, rounds, etc.).

Upon obtaining the multiplication proposal from the player #1, the gaming system provides authorization (209) of the proposal and the player. By way of non-limiting example, the system may check if the winning pool resulting from the obtained multiplication proposal fits the tournament limits, if the multiplication guarantee (or other financial guarantee received from the player) fits the pre-defined value, etc. In a certain embodiment of the invention the system may also re-calculate the multiplication guarantee corresponding to a current game situation and obtained multiplication proposal and to enable the player #1 to provide the guarantee after the proposal has been received. The multiplication guarantee amount may be taken out of the player's account and kept separately till the end of the game.

The authorized proposal is presented (210) to respective other player(s). The challenged player can accept or reject the multiplication proposal at this point and/or, optionally, may also initiate a further multiplication proposal. The system facilitates obtaining (211) the reply and further execution of the game in accordance with the obtained reply (212 or 213) and predefined game rules. If the multiplication proposal is accepted, the system multiplies the stakes and/or winning pool accordingly. Depending on the reply, the system may also define if there are other players to be challenged and facilitate the presenting of a respective proposal and obtaining the reply. In certain embodiments of the invention any player refusing the challenge may lose the game and leave the tournament.

Depending on the reply and predefined rules, the system updates accounts of respective players in accordance with usage of the multiplication guarantee (214).

Those skilled in the art will readily appreciate that the invention is not bound by the flowchart illustrated in FIG. 2; equivalent functions may be consolidated or divided in another manner, and sequence of some operations may be changed when appropriate.

Those skilled in the art will also appreciate that other types of tournament apply to the present invention where a plurality of players play at the same time as well as head on tournaments are played where one player loses or withdraws from the tournament, others may join in such a player's stead, and the tournament continues. It would be apparent to the person skilled in the art that same game tournament could be played with a multitude of players at the same time.

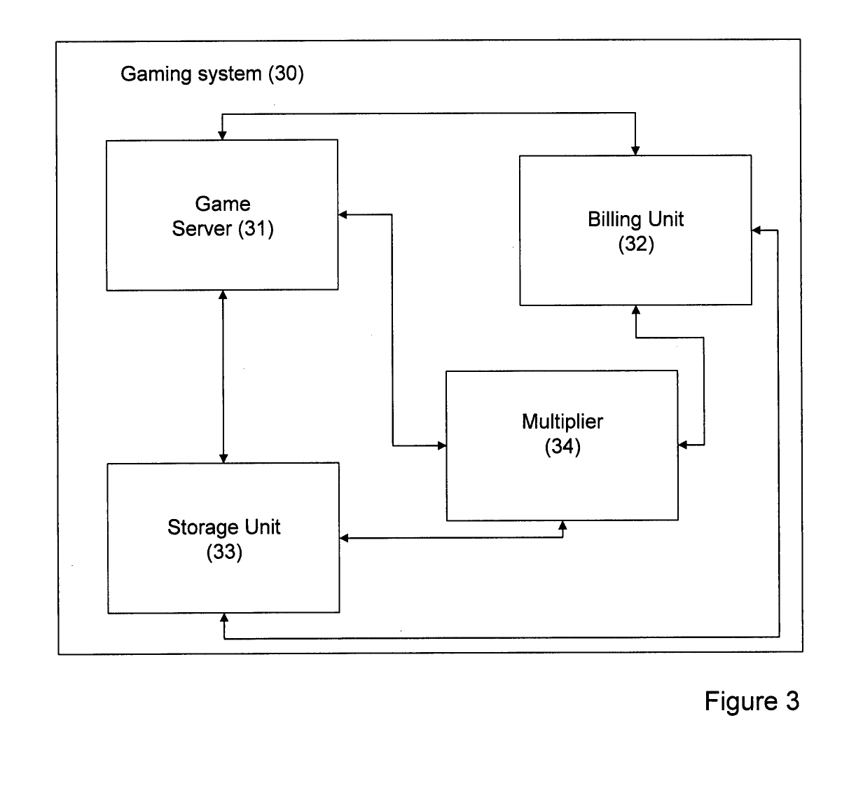

Referring now to FIG. 3, there is illustrated a generalized functional block diagram of the gaming system in accordance with certain embodiments of the present invention.

The gaming system 30 comprises operatively coupled game server 31, storage unit 33 and billing unit 32. In accordance with certain embodiments of the present invention, the gaming system further comprises a multiplier module 34 operatively coupled to the game server 31, storage unit 33 and billing unit 32. The multiplier module accommodates the game-related multiplication configuration and, optionally, the players'-related multiplication configuration detailed with reference to FIG. 2. Optionally this data or part thereof may be accommodated by the game server. The multiplier module is configured to obtain data from the game server and/or the billing unit and/or the storage unit, to process the obtained data as was detailed with reference to FIG. 2, and, depending on an outcome, to inform the game server and/or the billing unit with regard to a multiplication option and to update the storage unit accordingly.

In certain embodiments of the invention the game server is configured to recognize points in the game flow enabling multiplication proposal option (e.g. end of hands, beginning of new hands, new round, etc.) and to send the respective data to the multiplier module. In other embodiments of the present invention the game server may send (in pull and/or push mode) to the multiplier module game-related data necessary for checking conditions of multiplication proposal option regardless of recognized multiplication opportunities. Alternatively or additionally, the game server is configured to recognize a player's request for a multiplication proposal and to inform the multiplier module accordingly.

In accordance with certain embodiments of the present invention, the billing unit is configured to provide to the multiplier module finance-related data necessary for proposal/player authorization. In certain embodiments of the invention finance-related tournament limits are accommodated by the billing unit. Accordingly, the billing unit may send (in pull and/or push mode) to the multiplier module data and/or derivatives thereof related to said limits.

The storage unit is configured to provide (in pull and/or push mode) to the multiplier module with game-related data and user-related data necessary for checking a match to conditions and proposal/player authorization (e.g. number of played hands (and/or rounds) within the game and/or by a certain user, etc.).

In certain embodiments of the invention the multiplier module may be configured to request and obtain data related to the multiplication option from the game server and/or the billing unit and/or storage unit in accordance with in-between processing results based on data obtained in a push mode. Based on accommodated rules and conditions, the multiplier module may pull the data from the same source it got the pushed data and/or from another source.

The game server and/or billing unit are further configured to receive multiplication-related data from the multiplier module, and to enable interaction with the players with regard to the multiplication proposal. The interaction may be provided via the game client 10 and/or via external system(s) as, by way of non-limited example, phone or Internet. The billing unit is further configured to update the players' accounts in accordance with the multiplication proposal (e.g. reserve/release multiplication guarantee).

Those skilled in the art will readily appreciate that the invention is not bound by the configuration of FIG. 3; equivalent functionality may be consolidated or divided in another manner. In different embodiments of the invention the functional units and/or parts thereof may be placed in a single or in multiple geographical locations (including duplication for high-availability); operative connections between the units and within the units may be implemented directly or indirectly, including remote connection. The connection may be provided via Wire-line, Wireless, cable, Internet, Intranet, power, satellite or other networks and/or using any communication standard, system and/or protocol and variants or evolution thereof. The invention may also be practiced in distributed computing environments. The gaming system of the present invention may be also fully or partly integrated with different devices, including 3rd party equipment.

Those skilled in the art will also readily appreciate that the storage unit and the data accommodated therein may be divided between different parts of the gaming system in various manners. The accommodated data or part thereof may also be shared with other systems, including 3rd party equipment.

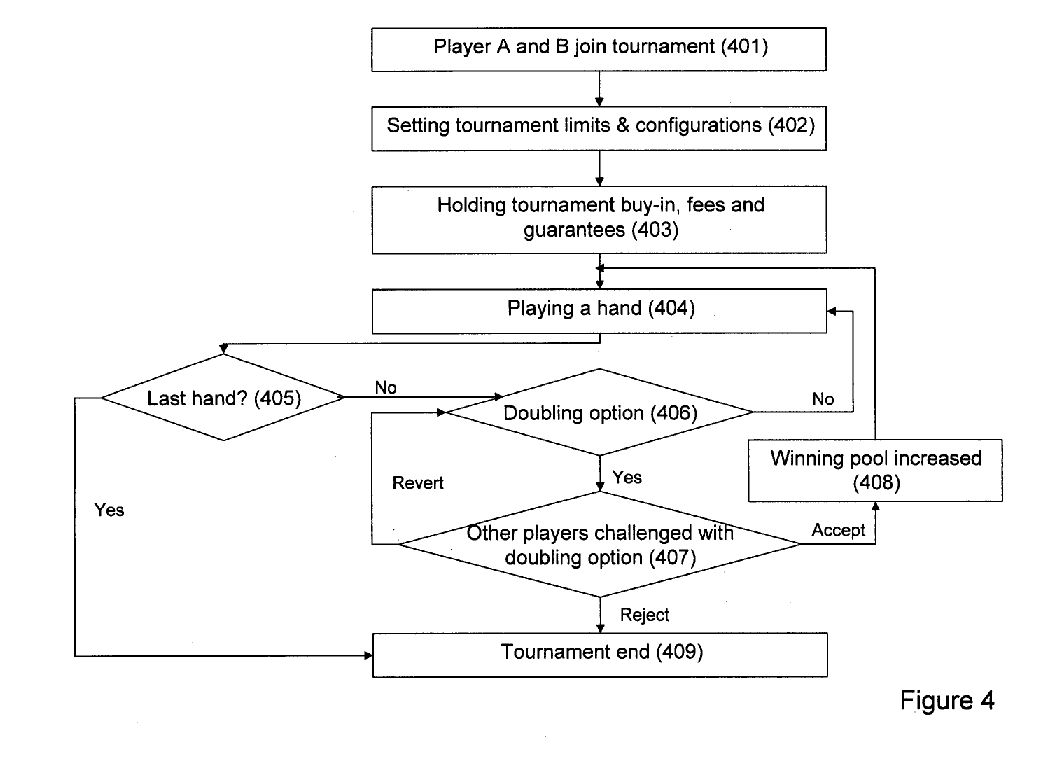

Referring now to FIG. 4, there is illustrated an exemplary game flow in accordance with certain embodiments of the present invention. For purpose of illustration only, the following description is made with respect to the tournament involving two players trying to beat one another at a head of the tournament. The multiplication parameter is constant along the game and equal to two. Those skilled in the art will readily appreciate that the teachings of the present invention are not bound by a two player poker game with doubling option provided at the head of the tournament and are applicable in a similar manner to other variants of poker tournaments and other multiplication options.

It shall be noted that in certain embodiments of the present invention one or more players may be simulated by the game system; the dealer's functions may be provided by the game system and/or by a human dealer followed by transmitting respective images and/or results to the players.

As explained above, a poker card game with double dice is preferably but not exclusively played in a heads-on tournament. Such a tournament involves two players or more trying to beat one another. It would be apparent to the person skilled in the art that any other variant of the game can be applied to the present invention.

In step 401 the players join the game. Joining the game may be provided through a registration process which may be accomplished by the players through completing of suitable forms through an electronic registration, via the phone or via video conferencing whereby a person associated with the organizers of the tournament completes the necessary stages of registration manually, or otherwise. In step 402 tournament limits and configurations are set as was detailed with reference to FIG. 2. In step 403 tournament buy-in, fees and multiplication guarantees are collected from each player. Optionally, this step may be a part of the registration process. In step 404 the hand starts and finishes. Upon completion of the step 404, the gaming system determines (405) whether the tournament hand that was played was the last hand to be played, as was predetermined in step 402 above. If the hand played was the last hand to be played, the game proceeds to step 409 where the tournament ends and the winner (e.g. the player who won the largest number of hands) may receive a prize. The prize can comprise the tournament buy-in and the doublings. In a typical tournament, the organizers may receive a portion of the winning prize. If the hand played at step 404 was not the last hand of the tournament, the game proceeds to step 406 where one or more players are provided with the doubling proposal option and enabled to perform the proposal in accordance to the rules of the tournament set in step 402. By way of non-limiting example, performing the doubling proposal may be time limited, mandatory, non-mandatory, allowed to a winner of the previous hand and/or to a loser of the previous hand, allowed to a player who paid more in the tournament buy-in fees, and the like; or, alternatively, allowed to all players. The interaction between the player and the gaming system while performing the doubling proposal may be provided in different ways, as, for example, verbal use of the term associated with the doubling proposal; a graphic representation of the doubling option on a screen display which a player may select or manipulate using an input device such as a mouse, keyboard, touch screen, and the like; a physical dice depicted such that the players will recognize the dice as a “doubling dice” of the present invention; a button or a lever associated and connected with a land based machine that is operative in the execution of the game of the present invention, and otherwise. If the doubling proposal is obtained and authorized by the game system during the step 406, the gaming system presents (407) the doubling proposal to the other player or players defined in accordance the rules pre-defined at step 402. If no authorized players perform the doubling proposal, the game returns to step 403 and a new hand begins.

In step 407, the player or players receiving the double proposal have to select between several options. If the challenged player accepts the doubling offer, the game proceeds to step 408 where the winning pool (and/or stakes) are increased in accordance with tournament rules and limits predetermined in step 402, and the game returns to the step 404 to play a new hand.

Optionally, in step 407 one or more challenged players can exercise a revert option. The “revert” option means that one or more challenged players accept the doubling proposal and further perform a new doubling proposal. Similar to step 406, the authorization of the proposal is provided in accordance with rules and limits set force in the step 402. In certain embodiments of the present invention, once a challenged player exercises the revert option, such a player becomes the confronting player and the confronting player becomes the challenged player, such that their roles are reversed.

If the challenged player rejects the doubling proposal, such a player forfeits the game and for that player the tournament ends (409) wherein the first player is declared as a winner.

Those skilled in the art will readily appreciate that various modifications and changes can be applied to the embodiments of the invention as hereinbefore described without departing from its scope, defined in and by the appended claims.

1.-24. (canceled)

25. A method of operating a computerized multiplayer tournament gaming system comprising a gaming server operatively coupled to a billing unit and a storage unit, the method comprising:
a) setting and accommodating a configuration comprising one or more predefined and/or configurable rules for multiplication of stakes and/or a winning pool, conditions thereof, one or more parameters of said multiplication, and one or more tournament limits;
b) facilitating obtaining a multiplication proposal from a player;
c) obtaining game-related and/or player-related data from at least one element from a group comprising the gaming server, the billing unit and the storage unit; and providing automated authorization of the proposal in accordance with said obtained data and said accommodated configuration;
d) presenting the authorized proposal to one or more other players and facilitating obtaining one or more respective replies,
e) automated informing the game server and/or the billing unit with regard to the multiplication proposal and reply thereof; and
f) automated executing the game rules corresponding to the obtained replies.

26. The method of claim 25 wherein the configuration comprises a multiplication parameter predefined as a constant throughout the game or a plurality of predefined multiplication parameters corresponding to different points of a game flow.

27. The method of claim 25 wherein the multiplication parameter is provided by a player together with the multiplication proposal and/or with reply thereof.

28. The method of claim 25, wherein the tournament limits comprise a multiplication guarantee limit defined for each player and/or certain groups of players and/or globally to the game.

29. The method of claim 25 further comprising re-configuring at least one tournament limit in accordance with obtained multiplication proposal and/or reply thereof and/or data obtained from at least one element from the group comprising the gaming server, the billing unit and the storage unit.

30. The method of claim 25 further comprising automated triggering of a multiplication proposal option, thus facilitating a player to provide the multiplication proposal.

31. The method of claim 30 wherein the automated triggering comprises automated recognition of a certain point in the game flow where the multiplication is allowed by the accommodated and automated verifying if this point meets the accommodated conditions for automated triggering, said verification provided in accordance with accommodated configuration and data obtained from at least one element from the group comprising the gaming server, the billing unit and the storage unit.

32. The method of claim 25 wherein the automated authorization comprises verifying at least one of the following:
a) if respective player is allowed to provide the multiplication proposal;
b) if the winning pool resulting from the obtained multiplication proposal fits the tournament limits,
c) if the multiplication guarantee obtained from the respective player fits the tournament pre-defined value,
wherein said verification is provided in accordance with accommodated configuration and data obtained from at least one element from the group comprising the gaming server, the billing unit and the storage unit.

33. The method of claim 25 further comprising automated defining the players who shall reply to the multiplication proposal in accordance with accommodated configuration and data obtained from at least one element from the group comprising the gaming server, the billing unit and the storage unit; and presenting the multiplication proposal accordingly.

34. A computer program comprising computer program code means for performing all the steps of claim 25 when said program is run on a computer.

35. A computer program as claimed in claim 34 embodied on a computer readable medium.

36. A computerized multiplayer tournament gaming system comprising a gaming server operatively coupled to a billing unit and a storage unit, wherein the system further comprises:
a) a multiplier module operatively coupled to at least one element of a group comprising the gaming server, the billing unit and the storage unit;
b) at least one element of said group is configured to provide game-related data and/or player-related data to the multiplier module;
c) the multiplier module is configured:
i) to accommodate a configuration comprising one or more predefined and/or configurable rules for multiplication of stakes and/or a winning pool, and/or conditions thereof, and/or one or more parameters of said multiplication, and/or one or more tournament limits;
ii) to obtain game-related data and/or player-related data from at least one element of said group;
iii) to facilitate obtaining a multiplication proposal from a player;
iv) to process the obtained data and the obtained multiplication proposal in accordance with the accommodated rules and conditions in order to provide an automated authorization of the proposal,
v) to facilitate presenting the authorized proposal to one or more other players and obtaining one or more respective replies, and
vi) to inform the game server and/or the billing unit with regard to the multiplication proposal and reply thereof.

37. The system of claim 36 wherein the configuration comprises a multiplication parameter predefined as a constant throughout the game or a plurality of predefined multiplication parameters corresponding to different points of a game flow.

38. The system of claim 36 wherein the multiplication parameter is provided by a player together with the multiplication proposal and/or with reply thereof.

39. The system of claim 36, wherein the tournament limits comprise a multiplication guarantee limit defined for each player and/or certain groups of players and/or globally to the game.

40. The system of claim 36 wherein the multiplier module is further configured to re-configure at least one tournament limit in accordance with obtained multiplication proposal and/or reply thereof and/or data obtained from at least one element from the group comprising the gaming server, the billing unit and the storage unit.

41. The system of claim 36 wherein the multiplier module is further configured to trigger a multiplication proposal option, thus facilitating a player to provide the multiplication proposal.

42. The system of claim 41 wherein:
a) at least one element from the group comprising the gaming server, the billing unit and the storage unit is configured to recognize a certain point in the game flow where the multiplication is allowed and to provide respective data to the multiplier module accordingly;
b) the multiplier module is configured to verify if this point meets the accommodated conditions for automated triggering, said verification to be provided in accordance with accommodated configuration and said provided respective data.

43. The system of claim 35 wherein the automated authorization comprises verifying at least one of the following:
a) if respective player is allowed to provide the multiplication proposal;
b) if the winning pool resulting from the obtained multiplication proposal fits the tournament limits,
c) if the multiplication guarantee obtained from the respective player fits the tournament pre-defined value,
wherein said verification is provided in accordance with accommodated configuration and data obtained from at least one element from the group comprising the gaming server, the billing unit and the storage unit.

44. The system of claim 36 wherein the multiplier module is further configured to define the players who shall reply to the multiplication proposal in accordance with accommodated configuration and data obtained from at least one element from the group comprising the gaming server, the billing unit and the storage unit; and to facilitate presenting the multiplication proposal accordingly.

45. A multiplier module configured for use with a computerized multiplayer tournament gaming system comprising a gaming server operatively coupled to a billing unit and a storage unit, wherein said multiplier module is operatively coupled to at least one element of a group comprising the gaming server, the billing unit and the storage unit and configured:
a) to accommodate a configuration comprising one or more predefined and/or configurable rules for multiplication of stakes and/or a winning pool, conditions thereof, one or more parameters of said multiplication, and one or more tournament limits;
b) to obtain game-related data and/or player-related data from at least one element of said group;
c) to facilitate obtaining a multiplication proposal from a player;
d) to process the obtained data and the obtained multiplication proposal in accordance with the accommodated rules and conditions in order to provide an automated authorization of the proposal,
e) to facilitate presenting the authorized proposal to one or more other players and obtaining one or more respective replies, and
f) to inform the game server and/or the billing unit with regard to the multiplication proposal and reply thereof.

46. The multiplier module of claim 45 further configured to obtain data from at least one element of said group in a pull mode.

47. The multiplier module of claim 45 further configured to obtain data from at least one element from said group in a push mode upon occurring a certain predefined event.

48. A method of playing a computerized multiplayer tournament game, the method comprising:
a) setting one or more rules for multiplication of stakes and/or a winning pool, conditions thereof, one or more parameters of said multiplication, and one or more tournament limits;
b) facilitating obtaining a multiplication proposal from a player;
c) automated authorization of the proposal in accordance with said rules and conditions;
d) presenting the authorized proposal to one or more other players and facilitating obtaining one or more respective replies,
automated executing the game rules corresponding to the obtained replies.
